(19) United States
(12) Patent Application Publication
(10) Pub. No.: US 2008/0181700 A1
(43) Pub. Date: Jul. 31, 2008

(54) Image processing system

(75) Inventor: Keiji Okumura, Osaka (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION

(21) Appl. No.: 12/010,528

(22) Filed: Jan. 25, 2008

(30) Foreign Application Priority Data
Jan. 31, 2007 (JP) 2007-020409

(51) Int. Cl. G03G 15/00

(52) U.S. Cl. 399/410

(57) ABSTRACT

An image processing system has a post-processing apparatus that can perform a stapling process. The post-processing apparatus is provided with: a processing tray on which a sheet of paper to be subjected to the stapling process is temporarily placed; a stapler performing the stapling process for the sheet of paper placed on the processing tray; an ejection tray on which an ejected sheet of paper is placed; and a switcher switching a destination of the sheet of paper ejected from an image forming apparatus between the processing tray and the ejection tray. If a number of sheets of paper fed from the image forming apparatus and a paper inserting apparatus is one, the switcher switches the destination of the sheet of paper to the ejection tray and the image processing system speedily ejects the sheet of paper without performing the stapling process, even when the stapling process is selected and inputted.

This application is based on Japanese Patent Application No. 2007-020409 filed on Jan. 31, 2007, the contents of which are hereby incorporated by reference.

### BACKGROUND OF THE INVENTION

1. Field of the Invention

The present invention relates to an image processing systems provided with a post-processing apparatus that can perform a stapling process.

2. Description of Related Art

In recent years, from the viewpoint of, for example, bringing efficiency to clerical work, post-processing apparatuses having processing mechanisms for processes such as a sorting process, a punching process for filing, a stapling process for stapling a plurality of sheets of paper, and a booklet process for folding a sheet of paper have come to be increasingly attached to image forming apparatuses forming an image on a sheet of paper, so as to form image processing systems.

As image processing systems are made multifunctional in this way, however, input operations using an operation panel become complicated, increasing the possibility of improper input. For example, if the user inadvertently selects and inputs a stapling process mode when there is only one sheet of paper to be conveyed from the image forming apparatus to the post-processing apparatus, the one sheet of paper, which does not need to be stapled under normal circumstances, is unnecessarily stapled.

To solve this problem, there have conventionally been proposed techniques for ejecting a sheet of paper without performing a stapling process if there is only one sheet of paper on a stapling process tray (hereinafter also referred to simply as the “processing tray”) even when the stapling process mode is selected and inputted (see, for example, JP-A-S62-196676, JP-A-S62-196677, and JP-A-S61-112167).

However, in the conventional proposed techniques described above, if the stapling process mode has been inputted and set, a sheet of paper is always conveyed into the processing tray even if there is only one sheet of paper. As a result, the sheet of paper is conveyed over longer distance as compared with when the stapling process is not performed. In addition, since there is a need for operations of conveying the sheet of paper into and out of the processing tray, it takes a long time to eject the sheet of paper from the post-processing apparatus. Furthermore, since the sheet of paper is conveyed over a long distance and is subjected to many operations, there is a high possibility that the sheet of paper suffers damage.

### SUMMARY OF THE INVENTION

In view of the conventionally experienced problems described above the present invention is made, and it is an object of the present invention to provide an image processing system provided with a post-processing apparatus that can perform a stapling process, the image processing systems that can eject a sheet of paper speedily without performing a stapling process, even when a stapling process mode is selected and inputted, if a number of sheets of paper fed from an image forming apparatus or the paper inserting apparatus is one.

According to a first aspect of the present invention, an image processing system is provided with: an image forming apparatus forming an image on a sheet of paper; and a post-processing apparatus performing a stapling process for the sheet of paper ejected from the image forming apparatus, and including a processing tray on which the sheet of paper to be subjected to the stapling process is temporarily placed, a stapler performing the stapling process for the sheet of paper placed on the processing tray, an ejection tray on which an ejected sheet of paper is placed, and a switcher switching a destination of the sheet of paper ejected from the image forming apparatus between the processing tray and the ejection tray. Here, when the stapling process is selected and inputted, if a number of sheets of paper ejected from the image forming apparatus is one, the switcher switches the destination of the sheet of paper to the ejection tray and the post-processing apparatus performs no stapling process, and if a number of sheets of paper ejected from the image forming apparatus is two or more, the switcher switches the destination of the sheets of paper to the processing tray and the post processing apparatus performs the stapling process.

According to a second aspect of the present invention, an image processing system is provided with: an image forming apparatus forming an image on a sheet of paper; a paper inserting apparatus feeding an insertion sheet; and a post-processing apparatus performing a stapling process for the sheet of paper on which the image is formed, the sheet of paper being ejected from the image forming apparatus, and the insertion sheet fed from the paper inserting apparatus, the post-processing apparatus including a processing tray on which the sheet of paper to be subjected to the stapling process is temporarily placed, a stapler performing the stapling process for the sheet of paper placed on the processing tray, an ejection tray on which an ejected sheet of paper is placed, and a switcher switching a destination of the sheet of paper between the processing tray and the ejection tray. Here, when the stapling process is selected and inputted, if a number of sheets of paper ejected from the image forming apparatus is one and no insertion sheet is fed from the paper inserting apparatus, or if no sheet of paper is ejected from the image forming apparatus and a number of insertion sheets fed from the paper inserting apparatus is one, the switcher switches the destination of the sheet of paper to the ejection tray, and the post-processing apparatus performs no stapling process, otherwise, the switcher switches the destination of the sheet of paper to the processing tray and the post-processing apparatus performs the stapling process.

Preferably, there may be provided an apparatus including, as a detector for detecting whether the number of insertion sheets fed from the paper inserting apparatus is one, a first detector for detecting the presence or absence of insertion sheets on a paper feed tray of the paper inserting apparatus and a second detector for detecting a passage of the insertion sheet over a paper conveying path running between the paper feed tray and the post-processing apparatus. After the insertion sheet starts being fed from the paper feed tray, if the first detector detects that no insertion sheet is placed on the paper feed tray when the insertion sheet thus fed is detected by the second detector, the number of insertion sheets fed from the paper inserting apparatus is judged to be one.

Preferably, from the viewpoint of further shortening the paper conveying path when no stapling process is performed, there may be provided, as the ejection tray of the post-processing apparatus, a first ejection tray into which the sheets of paper subjected to the stapling process are ejected, and a second ejection tray into which the sheet of paper that is not subjected to the stapling process is ejected.

In the image processing system according to the present invention, if the number of sheets of paper conveyed from the image forming apparatus and the paper inserting apparatus is one, the sheet of paper is ejected into the ejection tray with the switcher without being conveyed into the processing tray even when the stapling process is selected and inputted. This makes it possible to avoid the unnecessary stapling process. In addition, as compared with the conventional configuration, the distance over which the sheet of paper is conveyed within the post-processing apparatus is shortened, and, unlike the conventional configuration, there is no need for the operations of conveying the sheet of paper into and out of the processing tray. This helps reduce the time it takes to eject the sheet of paper from the post-processing apparatus, and makes the sheet of paper suffer less from damage.

By providing, as the ejection tray of the post-processing apparatus, the first ejection tray into which the sheets of paper subjected to the stapling process are ejected, and the second ejection tray into which the sheet of paper that is not subjected to the stapling process is ejected, it is possible to further shorten the paper conveying path when no stapling process is performed, and hence further reduce the time it takes to eject the sheet of paper from the post-processing apparatus.

### BRIEF DESCRIPTION OF THE DRAWINGS

FIG. 1 is a schematic diagram showing an example of an image processing system according to a first invention;

FIG. 2 is a diagram showing a paper conveying path in the post-processing apparatus shown in FIG. 1;

FIG. 3 is a flow chart showing an example of control performed by the image processing system according to the first invention;

FIG. 4 is a schematic diagram showing an example of an image processing system according to a second invention;

FIG. 5 is a flow chart showing an example of control performed by the image processing system according to the second invention; and

FIG. 6 is a flow chart showing another example of control performed by the image processing system according to the second invention.

### DETAILED DESCRIPTION OF PREFERRED EMBODIMENTS

Hereinafter, the present invention will be described with reference to the accompanying drawings. It is to be understood that the present invention is not limited in any way by the embodiments thereof described below.

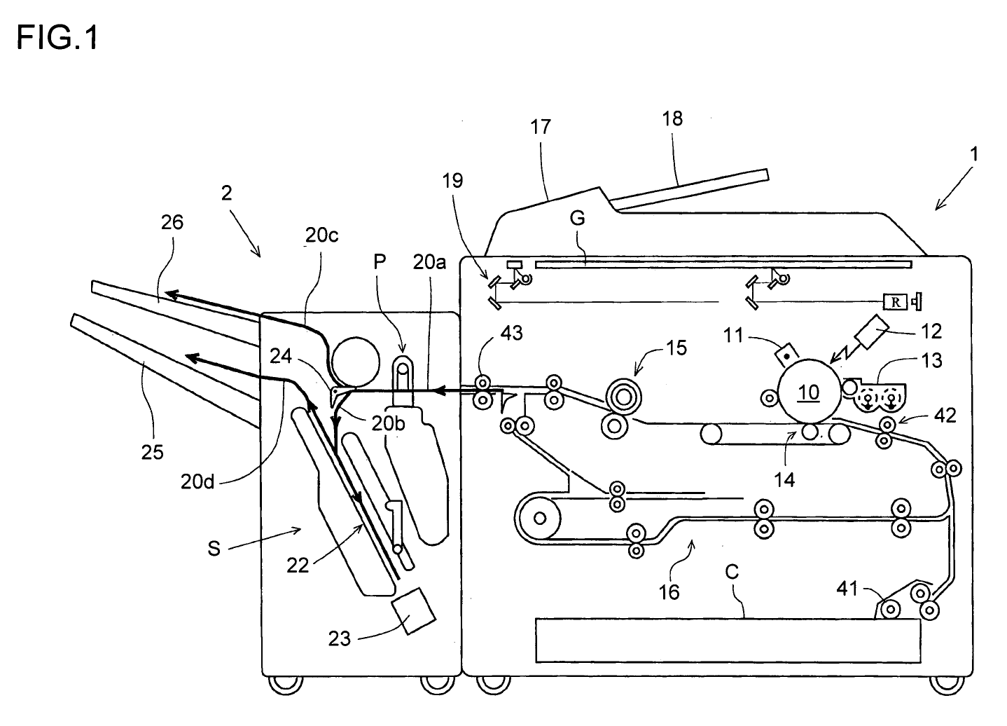

FIG. 1 is a schematic configuration diagram showing an example of an embodiment of an image processing system according to the invention. The image processing system shown in this figure includes an image forming apparatus 1 and a post-processing apparatus 2 attached to the image forming apparatus 1. First, a description will be given of the image forming apparatus 1. On a contact glass G, an automatic document feeder (ADF) 17 is placed in such a way that the contact glass G can be opened and closed therewith. Original documents (unillustrated) placed face up on a paper feed stage 18 of the ADF 17 are fed one sheet at a time, beginning with the topmost one. The original document thus fed is conveyed to a reading portion 19, where an image of the original document is inputted to an image input portion R as a digital signal. After passing through the reading portion 19, the original document is ejected into an ejection tray (unillustrated) formed below the paper feed stage 18.

On the other hand, sheets of paper held in a paper feed cassette C is fed with a pickup roller 41 one sheet at a time, and is then conveyed along a conveying path. Then, the sheet of paper is made to wait with the leading edge thereof aligned by a pair of resist rollers 42, and is then conveyed to a photoconductor drum 10 with predetermined timing. After the surface of the photoconductor drum 10 is evenly charged with a charger unit 11, an electrostatic latent image is formed on the photoconductor drum 10 by an exposure unit 12 based on the image data inputted to the image input portion R. The electrostatic latent image thus formed is developed as a toner image with toner supplied from a developer unit 13, and is then transferred to the conveyed sheet of paper with a transfer roller 14. The sheet of paper to which the toner image is transferred is conveyed to a pair of fusing rollers 15, and is then heated with a heating roller and subjected to a pressure with a pressure roller, whereby the toner image is fused to the sheet of paper. In a case where the toner image is formed on both sides of the sheet of paper, the sheet of paper is conveyed to a reversal conveyance mechanism 16 and is then subjected to the above-described process again, whereby the toner image is formed on and fused to both sides of the sheet of paper. The sheet of paper to which the toner image is fused is ejected through a pair of ejection rollers 43 into the post-processing apparatus 2 via an ejection port.

The post-processing apparatus 2 is provided with a punching unit P that punches a hole in the sheet of paper, and a stapling unit S that performs a stapling process for the sheet of paper. The punching unit P punches a hole in the sheet of paper to make filing thereof possible. As the punching unit P, any conventionally known mechanism can be used. The stapling unit S includes a processing tray 22 on which the conveyed sheet of paper is temporarily placed, and a stapler 23 that performs a stapling process for the sheet of paper placed on the processing tray 22. It is needless to say that the post-processing apparatus 2 may be provided with any other conventionally known mechanism such as a folding mechanism.

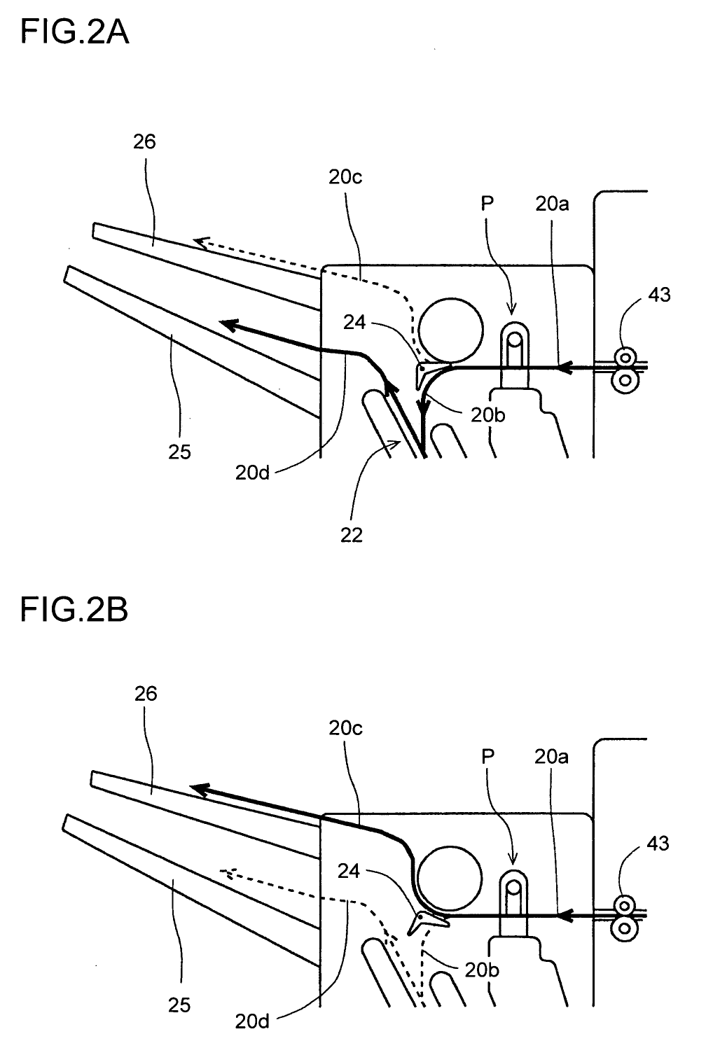

The sheet of paper ejected from the image forming apparatus 1 is conveyed to a conveying path 20a of the post-processing apparatus 2. After being punched for filing by the punching unit P as needed, the sheet of paper arrives at a flap (switcher) 24. Here, if the stapling process is selected and inputted, as shown in FIG. 2A, the sheet of paper is sent to a conveying path 20b with the flap 24, and is then conveyed into the processing tray 22. After a series of sheets of paper is conveyed into the processing tray 22, the stapling process is performed with the stapler 23. The stapled sheets of paper are ejected into a main tray (first ejection tray) 25 through a conveying path 20d.

On the other hand, if the stapling process is not selected and inputted, as shown in FIG. 2B, the sheet of paper is sent to a conveying path 20c with the flap 24, and is then ejected into a subtray (second ejection tray) 26. The embodiment described above deals with a case in which the stapled sheets of paper and the unstapled sheet of paper are ejected into different ejection trays 25 and 26, respectively. However, it is also possible to eject them into the same ejection tray. Incidentally, the number of ejection trays may be one. It is needless to say that two or more ejection trays may be provided.

In the image processing system configured as described above, according to a first invention, control is so performed that, if a number of sheets of paper ejected from the image forming apparatus 1 is one, it is sent to the conveying path 20c with the flap 24 even when the stapling process is selected and inputted, and is then ejected into the subtray 26. This makes it possible to avoid the unnecessary stapling process, shorten the paper conveying path, and skip the operations of conveying the sheet of paper into and out of the processing tray 22. This makes it possible to speedily eject the sheet of paper from the post-processing apparatus 2.

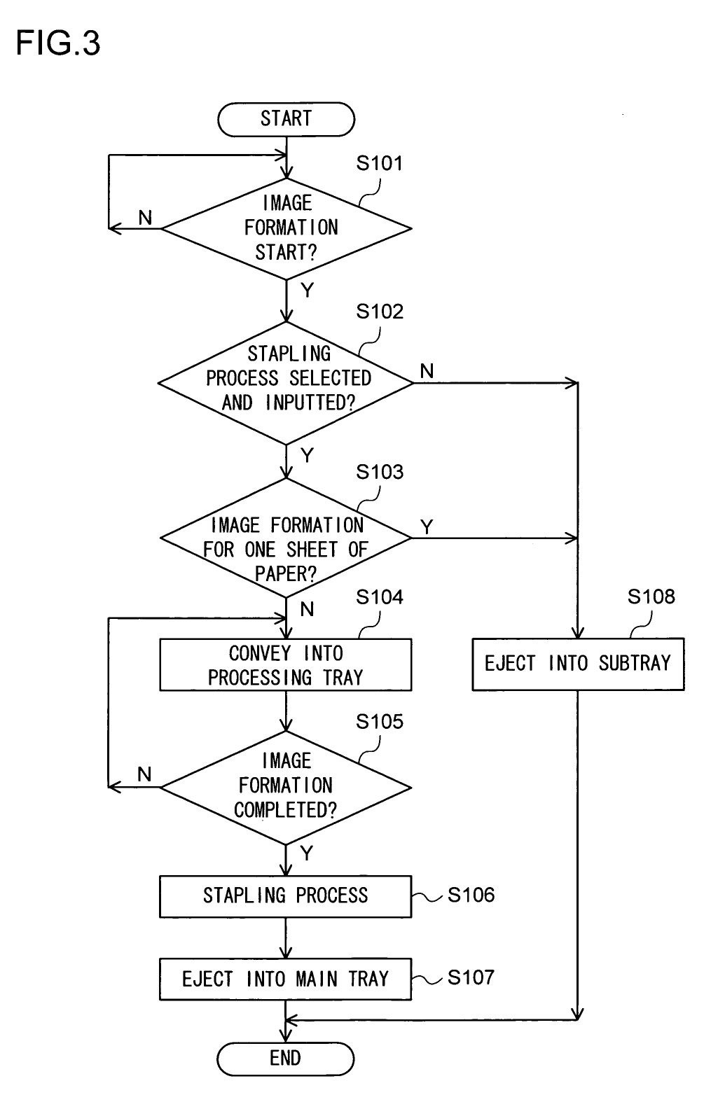

FIG. 3 is a flow chart showing such control. When the image forming apparatus 1 starts image formation (step S101), it is first judged whether the stapling process is selected and inputted (step S102). If the stapling process is found to be selected and inputted, it is then judged whether or not image formation is performed for one sheet of paper based on input information on the number of sheets of paper instructed from an operating portion of the image forming apparatus (step S103). If image formation is found to be performed for more than one sheet of paper, that is, performed for two or more sheets of paper, the sheet of paper ejected from the image forming apparatus is conveyed into the processing tray of the post-processing apparatus (step S104). After image formation for a series of sheets of paper is completed and the resultant sheets of paper are conveyed into the processing tray 22 (step S105), the stapling process is performed with the stapler 23 (step S106). The stapled sheets of paper are ejected into the main tray 25 (step S107).

On the other hand, if the stapling process is found not to be selected and inputted (step S102), or if image formation is found to be performed for one sheet of paper even though the stapling process is selected and inputted (step S103), the sheet of paper conveyed from the image forming apparatus 1 to the post-processing apparatus 2 is immediately ejected into the subtray 26 without being conveyed into the processing tray 22 (step S108).

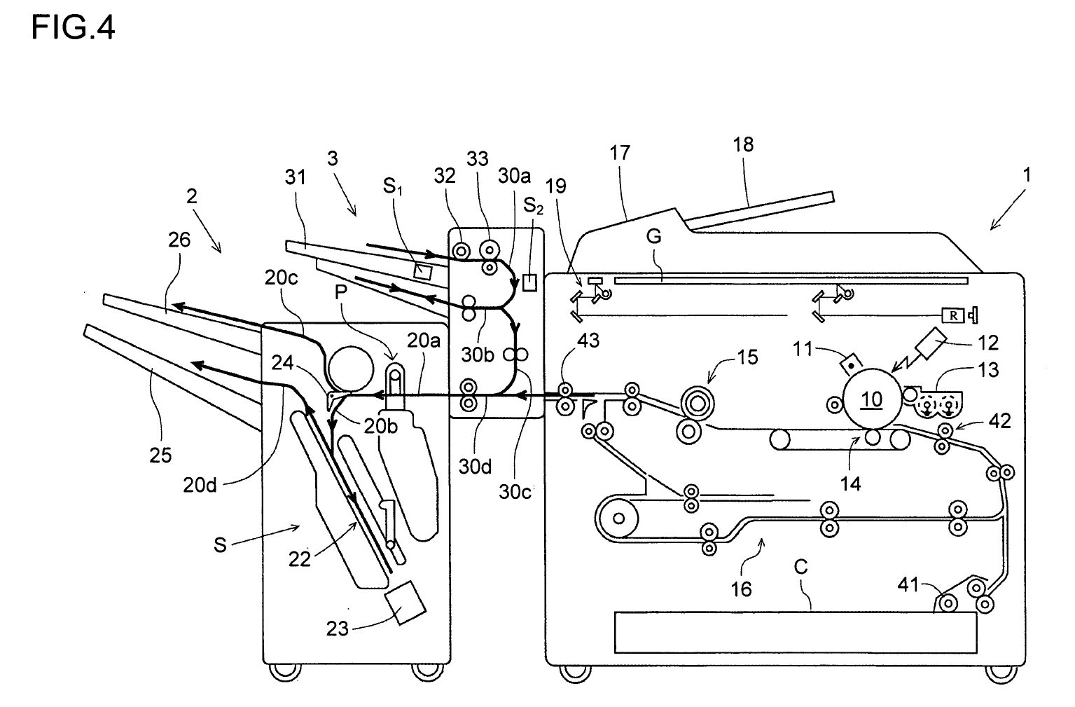

Next, an image processing system according to a second invention will be described. FIG. 4 is a schematic diagram showing an example of an image processing system according to the second invention. The image processing system according to this invention differs from the image processing system according to the first invention described above in that a paper inserting apparatus 3 is provided between the image forming apparatus 1 and the post-processing apparatus 2. The paper inserting apparatus 3 inserts insertion sheets, such as front and back covers printed in color and slip sheets, between the sheets of paper ejected from the image forming apparatus 1 when producing, for example, a booklet by using the image processing system.

A description will be given below of the specific operation of the paper inserting apparatus 3. The insertion sheets placed face up in a predetermined order on a paper feed tray 31 of the paper inserting apparatus 3 are sent to a conveying path 30a with a pickup roller 32. If a sheet of paper is ejected from the image forming apparatus 1 with the image formation side up, the insertion sheet is conveyed to a switchback conveying path 30b and is turned over. As a result, the insertion sheet is to be inserted face up between the sheets of paper ejected from the image forming apparatus 1 with the image formation side up. The insertion sheet is sent, via a conveying path 30c, to a conveying path 30d connecting between the image forming apparatus 1 and the post-processing apparatus 2. If the sheet of paper is ejected from the image forming apparatus 1 with the image formation side down, the insertion sheet is sent, via the conveying path 30c, to the conveying path 30d without being conveyed to the switchback conveying path 30b.

The sheet of paper conveyed from the image forming apparatus 1 and the paper inserting apparatus 3 to the post-processing apparatus 2 is punched for filing by the punching unit P as needed. If the stapling process is selected and inputted, the sheet of paper is sent to the conveying path 20b with the flap 24, and is conveyed into the processing tray 22. After being subjected to the stapling process, the sheets of paper are ejected into the main tray 25. On the other hand, if the stapling process is not selected and inputted, the sheet of paper is sent to the conveying path 20c with the flap 24, and is then ejected into the subtray 26.

In this application, in the second invention, control is so performed that, if no sheet of paper is ejected from the image forming apparatus 1 and the number of insertion sheets fed from the paper inserting apparatus 3 is one, the sheet is sent to the conveying path 20c with the flap 24 even when the stapling process is selected and inputted, and is then ejected into the subtray 26. In addition, as is the case with the first invention, control is so performed that, if the number of sheets of paper ejected from the image forming apparatus 1 is one and no insertion sheet is fed from the paper inserting apparatus 3, the sheet is sent to the conveying path 20c with the flap 24 and is then ejected into the subtray 26. This makes it possible to avoid the unnecessary stapling process, shorten the paper conveying path, and skip the operations of conveying the sheet of paper into and out of the processing tray 22. This makes it possible to speedily eject the sheet of paper from the post-processing apparatus 2.

The following is an example of how to detect whether the number of insertion sheets fed from the paper inserting apparatus 3 is one. A first sensor S1 for detecting the presence or absence of insertion sheets on the paper feed tray is provided in the paper feed tray 31 used for holding the insertion sheets, and a second sensor S2 for detecting a passage of the rear edge of an insertion sheet is provided somewhere along the conveying path 30a. After an insertion sheet starts being fed from the paper feed tray 31, if the first sensor S1 detects that no insertion sheet is placed on the paper feed tray 31 when the insertion sheet thus fed is detected by the second sensor S2, the number of insertion sheets fed from the paper inserting apparatus 3 is judged to be one.

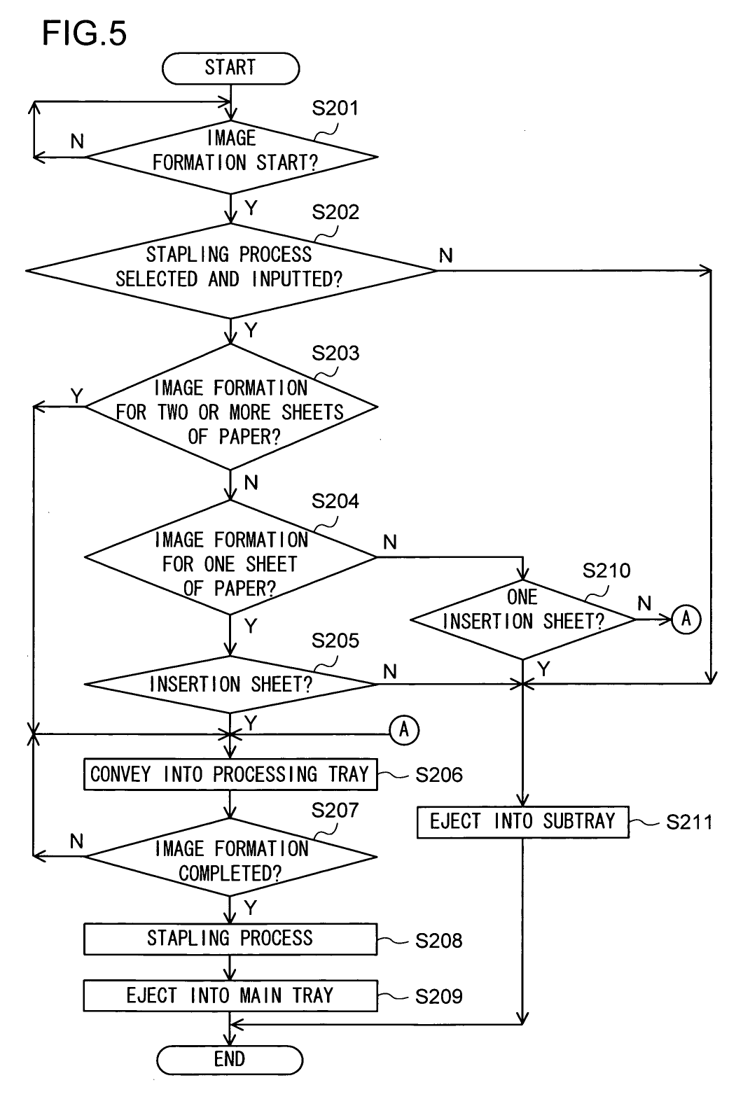

FIG. 5 is a flow chart showing an example of control performed by the image processing system configured as described above. When the image forming apparatus 1 starts image formation (step S201), it is judged whether or not the stapling process is selected and inputted (step S202). If the stapling process is found to be selected and inputted, it is then judged whether or not image formation is performed for two or more sheets of paper (step S203). If image formation is found to be performed for two or more sheets of paper, if image formation is found to be performed for one sheet of paper (step S204) and an insertion sheet is found to be present (step S205), or if image formation is found not to be performed for any sheet of paper (step S204) and two or more insertion sheets are found to be present (step S210), the sheets of paper are conveyed into the processing tray 22 of the post-processing apparatus 2 (step S206). As is the case with the flow chart shown in FIG. 3, after image formation for a series of sheets of paper is completed and then the resultant sheets of paper are conveyed into the processing tray 22 (step S207), the stapling process is performed with the stapler 23 (step S208). The stapled sheets of paper are ejected into the main tray 25 (step S209).

On the other hand, if the stapling process is found not to be selected and inputted (step S202), if image formation is found to be performed for one sheet of paper (step S204) and no insertion sheet is found to be present (step S205) even when the stapling process is selected and inputted, or if image formation is found not to be performed for any sheet of paper (step S204) and the number of insertion sheets is found to be one (step S210), the sheet of paper sent to the post-processing apparatus 2 is immediately ejected into the subtray 26 without being conveyed into the processing tray 22 (step S211).

One of the applications of the paper inserting apparatus 3 configured as described is an application where a bound booklet to be copied is temporarily disassembled into separate sheets of paper, and, after being copied, they are bound again into the original form. In particular, the paper inserting apparatus 3 is used to bind so large a number of sheets of paper that they cannot be bound with a commercially available stapler. Specifically, the stapling process is selected and inputted with the separate sheets of paper of the disassembled booklet placed on the paper feed tray 31 of the paper inserting apparatus 3, whereby the separate sheets of paper are sent into the processing tray 22 of the post-processing apparatus 2 and are stapled together with the stapling unit S of the post-processing apparatus 2. Also in this case, if the number of sheets of paper placed on the paper feed tray 31 as original documents to be stapled is one, control is so performed that the sheet of paper is sent to the conveying path 20c with the flap 24 and is then ejected into the subtray 26.

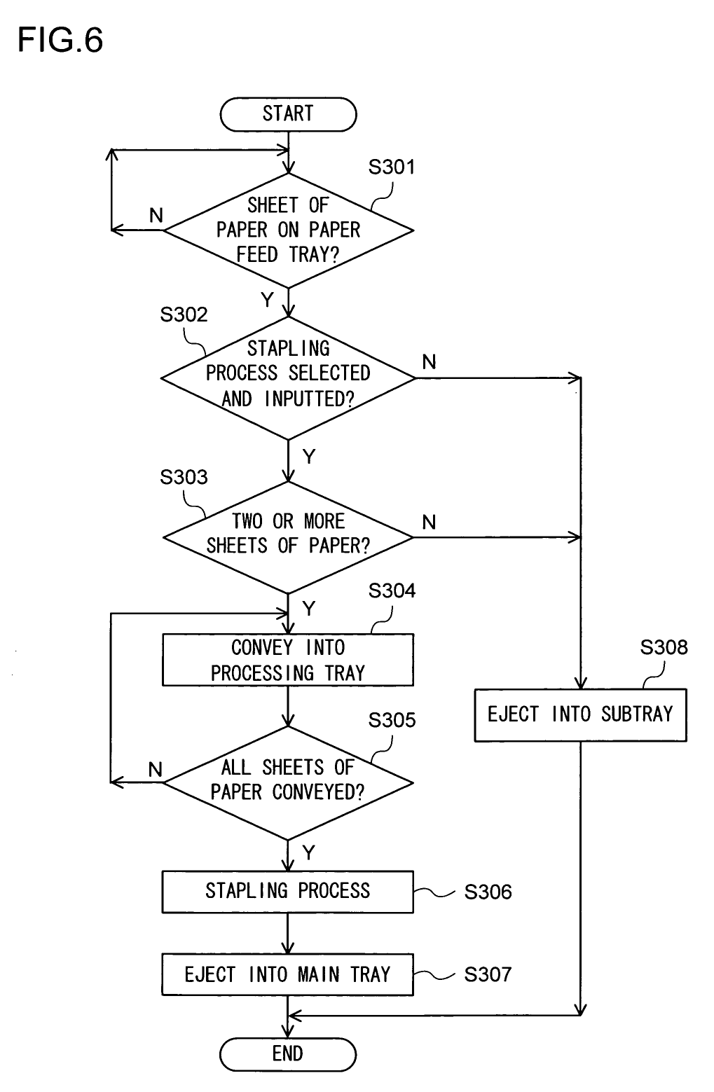

FIG. 6 is a flow chart showing an example of such control. First, it is judged whether or not there is a sheet of paper to be stapled, such as an original document, on the paper feed tray 31 of the paper inserting apparatus 3 (step S301). If the sheet of paper is found to be placed on the paper feed tray 31, it is then judged whether or not the stapling process is selected and inputted (step S302). If the stapling process is found to be selected and inputted, it is then judged whether or not two or more sheets of paper are placed on the paper feed tray 31 (step S303). If it is found that there are two or more sheets of paper (step S303), these sheets of paper are conveyed into the processing tray 22 of the post-processing apparatus 2 (step S304). After a series of sheets of paper is conveyed into the processing tray 22 (step S305), the stapling process is performed with the stapler 23 (step S306). The stapled sheets of paper are ejected into the main tray 25 (step S307).

On the other hand, if the stapling process is found not to be selected and inputted (step S302), or if the number of sheets of paper on the paper feed tray 31 is found to be one even when the stapling process is selected and inputted (step S303), the sheet of paper sent to the post-processing apparatus 2 is immediately ejected into the subtray 26 without being conveyed into the processing tray 22 (step S308).

Incidentally, FIG. 4 deals with an image processing system in which the post-processing apparatus 2 and the paper inserting apparatus 3 are provided separately; however, needless to say, they may be integrated into one apparatus.

What is claimed is:

1. An image processing system, comprising: an image forming apparatus forming an image on a sheet of paper; and
a post-processing apparatus performing a stapling process for the sheet of paper ejected from the image forming apparatus, the post-processing apparatus comprising:
a processing tray on which the sheet of paper to be subjected to the stapling process is temporarily placed;
a stapler performing the stapling process for the sheet of paper placed on the processing tray;
an ejection tray on which an ejected sheet of paper is placed; and
a switcher switching a destination of the sheet of paper ejected from the image forming apparatus between the processing tray and the ejection tray,
when the stapling process is selected and inputted,
if a number of sheets of paper ejected from the image forming apparatus is one,
the switcher switches the destination of the sheet of paper to the ejection tray and the post-processing apparatus performs no stapling process, and
if a number of sheets of paper ejected from the image forming apparatus is two or more,
the switcher switches the destination of the sheets of paper to the processing tray and the post processing apparatus performs the stapling process.

2. An image processing system, comprising:
an image forming apparatus forming an image on a sheet of paper;
a paper inserting apparatus feeding an insertion sheet; and
a post-processing apparatus performing a stapling process for the sheet of paper on which the image is formed, the sheet of paper being ejected from the image forming apparatus, and the insertion sheet fed from the paper inserting apparatus, the post-processing apparatus comprising:
a processing tray on which the sheet of paper to be subjected to the stapling process is temporarily placed;
a stapler performing the stapling process for the sheet of paper placed on the processing tray;
an ejection tray on which an ejected sheet of paper is placed; and
a switcher switching a destination of the sheet of paper between the processing tray and the ejection tray,
when the stapling process is selected and inputted,
if a number of sheets of paper ejected from the image forming apparatus is one and no insertion sheet is fed from the paper inserting apparatus, or
if no sheet of paper is ejected from the image forming apparatus and a number of insertion sheets fed from the paper inserting apparatus is one,
the switcher switches the destination of the sheet of paper to the ejection tray, and the post-processing apparatus performs no stapling process,
otherwise, the switcher switches the destination of the sheet of paper to the processing tray and the post-processing apparatus performs the stapling process.

3. The image processing system of claim 2 wherein the paper inserting apparatus comprises:
a paper feed tray on which the insertion sheet is placed;
a first detector for detecting a presence or absence of insertion sheets on the paper feed tray; and
a second detector provided in a predetermined position along a paper conveying path running between the paper feed tray and the post-processing apparatus,
and wherein, after the insertion sheet starts being fed from the paper feed tray, if the first detector detects that no insertion sheet is placed on the paper feed tray when the insertion sheet thus fed is detected by the second detector, the number of insertion sheets fed from the paper inserting apparatus is judged to be one.

4. The image processing system of claim 1 wherein the post-processing apparatus comprises:
a first ejection tray into which the sheets of paper subjected to the stapling process are ejected; and
a second ejection tray into which the sheet of paper that is not subjected to the stapling process is ejected.

5. The image processing system of claim 2 wherein the post-processing apparatus comprises:
a first ejection tray into which the sheets of paper subjected to the stapling process are ejected; and
a second ejection tray into which the sheet of paper that is not subjected to the stapling process is ejected.

6. The image processing system of claim 3 wherein the post-processing apparatus comprises:
a first ejection tray into which the sheets of paper subjected to the stapling process are ejected; and
a second ejection tray into which the sheet of paper that is not subjected to the stapling process is ejected.
